(19) United States
(12) Patent Application Publication
(10) Pub. No.: US 2023/0130024 A1
(43) Pub. Date: Apr. 27, 2023

(54) SYSTEM AND METHOD FOR STORING ENCRYPTION KEYS FOR PROCESSING A SECURED TRANSACTION ON A BLOCKCHAIN

(71) Applicant: Vesto LLC, Walnut Creek, CA (US)

(72) Inventors: Christopher Melchin Mcgregor, Mcgregor, CA (US); Travis Melchin Mcgregor, Greenbrae, CA (US); Wolfgang Decker, Berlin (DE)

(21) Appl. No.: 17/511,583

(22) Filed: Oct. 27, 2021

(51) Int. Cl. G06Q 20/38; H04L 9/32; H04L 29/08

(52) U.S. Cl. CPC G06Q 20/3829; G06Q 20/3827; G06Q 20/38215; H04L 9/3247; H04L 67/1097; H04L 2209/38; H04L 2209/56

(57) ABSTRACT

A method for storing a plurality of encryption keys for processing a secured transaction on a blockchain includes: configuring at least one user device to authorize at least one user for performing the secured transaction; deploying a smart contract on the blockchain for the at least one user; storing a first private key in a memory of the at least one user device; storing a second private key in a cloud server; initiating a request for the at least one transaction by using the second private key by the cloud server; receiving from the cloud server, a notification on the at least one user device for signing the at least one transaction; using the first private key to generate a first signature in response to the at least one transaction; and sending the signed at least one transaction on the blockchain to process the at least one transaction.

### FIELD OF THE DISCLOSURE

The present invention relates generally to the field of cryptocurrency transactions on distributed ledger platforms, and, more particularly, to a system and method for storing encryption keys at a secured location for processing a secured transaction on a blockchain.

### BACKGROUND OF THE DISCLOSURE

Cryptography is a set of techniques for safeguarding data on an electronic device’s hard disk, such as in the case that the device is lost or stolen. In some situations, data on the electronic device’s hard disc may be protected with cryptographic keys. Further, the cryptographic keys may be required as online asset transactions are prone to cyberattacks, fraud, delays, limited transparencies, and difficulty in detecting errors. Furthermore, a pair of cryptographic keys for example a public key and a private key, are used to establish ownership of the digital assets in a blockchain network. Many of these drawbacks are mitigated by the use of blockchain technology.

The blockchain technology allows a user to create digital wallets. The digital wallets are classified as a hot storage wallet and a cold storage wallet. Moreover, the hot storage wallet is an online wallet couple to an internet service while the cold storage wallet is the offline wallet which is not coupled to the internet, rather used as backup.

When a blockchain network is connected to the Internet, it is necessary to protect the private keys. Existing system and method fail to complete a secure transaction over the blockchain. Accordingly, there exists a need to overcome shortcomings of the conventional systems and methods for securing and approving transactions on the blockchain.

### SUMMARY OF THE DISCLOSURE

In view of the foregoing disadvantages inherent in the prior art, the general purpose of the present disclosure is to enhance multi-factor authentication, as solutions to one or more of the above-mentioned technical problems.

An object of the present disclosure is to provide a combination that may create highest level of security to prevent cybercrimes, such as SIM swap attacks, data breaches, phishing, and others.

An object of the present disclosure is to provide a multi-factor authenticator and approver of any transaction to transfer tokens or call a function of a smart contract on the blockchain.

Another object of the present disclosure is to store at least one private key in a secure element to sign an entire transaction or a subset of transaction for approval.

According to an embodiment of the present invention, a method for storing a plurality of encryption keys, the plurality of encryption keys being used for processing a secured transaction on a blockchain is provided. The method includes configuring at least one user device to authorize at least one user for performing the secured transaction. The at least one user device may be associated with the at least one user. Further, the at least one user may be authorized based on verification of at least one identity information. The method also includes deploying a smart contract on the blockchain for the at least one user. The smart contract may be associated with the plurality of encryption keys and may be created in response to a request to perform at least one transaction of the secured transaction. Moreover, the plurality of encryption keys may include a set of public keys and a set of private keys. The method also includes storing a first private key in a memory of the at least one user device. The first private key is generated on the at least one user device and belongs to the set of private keys. The method also includes storing a second private key in a cloud server. The second private key may belong to the set of private keys. The method also includes initiating a request for the at least one transaction by using the second private key by the cloud server. The method also includes receiving from the cloud server, a notification on the at least one user device for signing the at least one transaction. The method also includes using the first private key to generate a first signature in response to the at least one transaction, by the at least one user device, for signing the at least one transaction. The method also includes sending the signed at least one transaction on the blockchain to process the at least one transaction.

In one embodiment of the present disclosure, the secured transaction includes one or more transactions pertaining to cryptocurrencies, banking transactions, sensitive data transactions, identity information validation transaction.

In one embodiment of the present disclosure, the at least one transaction includes transferring of tokens, calling a cryptocurrency function of a smart contract by the second private key in the cloud server.

In one embodiment of the present disclosure, wherein the at least one transaction is a subset of the secured transaction.

In one embodiment of the present disclosure, the first private key and the second private key corresponds to the at least one transaction being processed on the blockchain.

In one embodiment of the present disclosure, the at least one user device and the cloud server are separate devices that may store the first private key and the second private key respectively thereby allowing the first private key and the second private key to be independent of each other.

In one embodiment of the present disclosure, the storing a third private key in a backup storage device, the third private key belonging to the set of private keys.

In one embodiment of the present disclosure, the third private key is used as a backup to perform the first transaction when the first private key and the second private key are compromised due to any unexpected event.

In one embodiment of the present disclosure, the verification of at least one identity information of the at least one user is based on at least one of: a biometric verification, a passcode verification, a location-based verification, an audio recognition-based verification, digital certificates-based verification, emails, and text message-based verification.

In one embodiment of the present disclosure, a portable identification (PID) of the authorized at least one user is stored in the memory of the at least one user device, the portable identification (PID) being generated during the verification of at least one identity information.

Embodiments in accordance with the present invention provide a system for storing a plurality of encryption keys. Moreover, the plurality of encryption keys may be used for processing a secured transaction on a blockchain. The system includes at least one user device configured to authorize at least one user for performing the secured transaction. The at least one user device may be associated with the at least one user. The at least one user may be authorized based on verification of at least one identity information. The system also includes a cloud server configured to deploy a smart contract on the blockchain for the at least one user. The smart contract may be associated with the plurality of encryption keys and is being created in response to a request to perform at least one transaction of the secured transaction. Further, the plurality of encryption keys may include a set of public keys and a set of private keys. The system also includes a processing module in communication with the at least one user device and the cloud server. The processing module may be configured to store a first private key in a memory of the at least one user device. The first private key is generated on the at least one user device and belongs to the set of private keys. The processing module may also be configured to store a second private key in a cloud server, the second private key belonging to the set of private keys, initiate a request for the at least one transaction by using the second private key by the cloud server. The processing module may also be configured to send a notification, via the cloud server, to the at least one user device for signing the at least one transaction. The processing module may also be configured to use the first private key, via the at least one user device, to generate a first signature in response to the at least one transaction for signing the at least one transaction. The processing module may also be configured to send the signed at least one transaction on the blockchain to process the at least one transaction.

This together with the other aspects of the present disclosure, along with the various features of novelty that characterize the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description taken in conjunction with the accompanying drawing, in which:

FIG. 1A illustrates a block diagram of a system for storing a plurality of encryption keys, according to embodiments of the present invention disclosed herein;

FIG. 1B illustrates a schematic representation of a process for storing the plurality of encryption keys in at least one user device, according to embodiments of the present invention disclosed herein;

FIG. 1C illustrates a schematic representation of a smart contract deployed on the blockchain with the set of private keys, according to embodiments of the present invention disclosed herein;

FIG. 1D illustrates a schematic view of the at least one user device of the system of FIG. 1A, according to embodiments of the present invention disclosed herein;

FIG. 1E illustrates a block diagram of components of a processing module of the system, according to embodiments of the present invention disclosed herein; and

FIG. 2 is an illustration of method steps for storing a plurality of encryption keys for processing a secured transaction on a blockchain, according to embodiments of the present invention disclosed herein.

Like reference numerals refer to like parts throughout the description of several views of the drawing.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The embodiments described herein detail for illustrative purposes are subject to many variations in implementation. The present invention provides a system and a method for storing a plurality of encryption keys. It should be emphasized, however, that the present disclosure is not limited only to what is disclosed and extends to cover various alternation to the system and method for storing a plurality of encryption keys for a secured transaction over a blockchain. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced items.

The terms “having”, “comprising”, “including”, and variations thereof signify the presence of a component.

The present invention relates to a system and method for storing a plurality of encryption keys in a secure element present in at least one user device. Further, the plurality of encryption keys may be used for processing a secured transaction on a blockchain. Moreover, at least one secure cryptocurrency transaction may be performed with multi-factor authentication, from cryptocurrency wallets in communication with multiple distributed ledgers.

As used herein, ‘module’ or ‘unit’ may refer to a device, a system, a hardware, a computer application configured to execute specific functions or instructions according to the embodiments of the present invention. The module or unit may include a single device or multiple devices configured to perform specific functions according to the present invention disclosed herein.

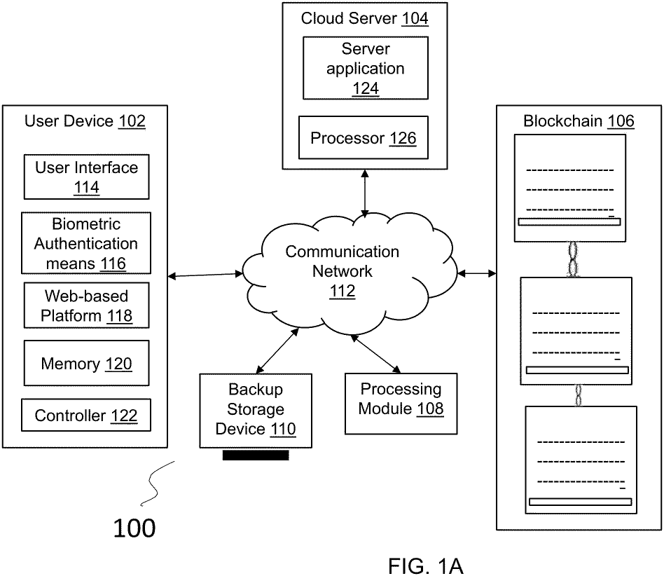

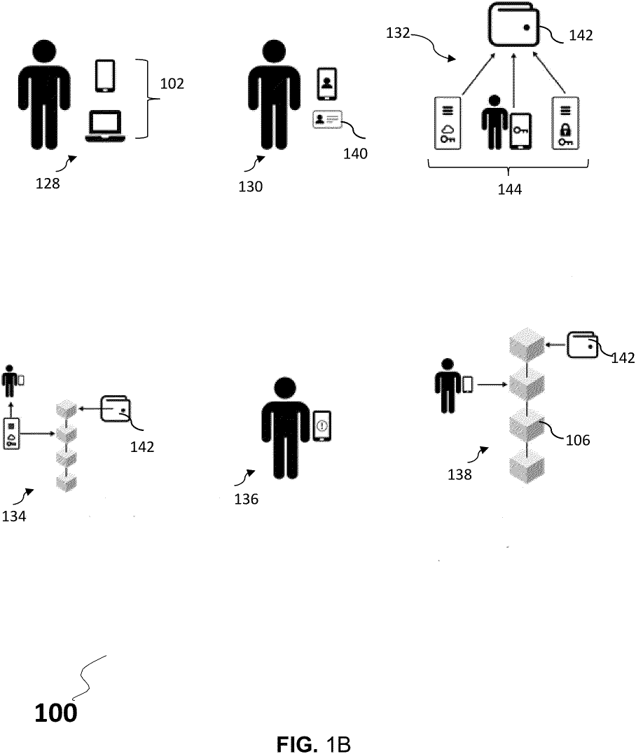

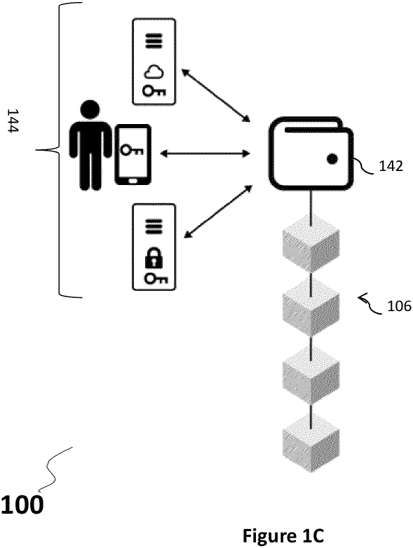

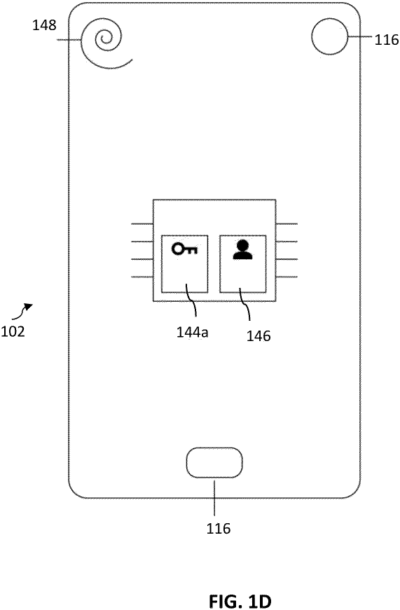

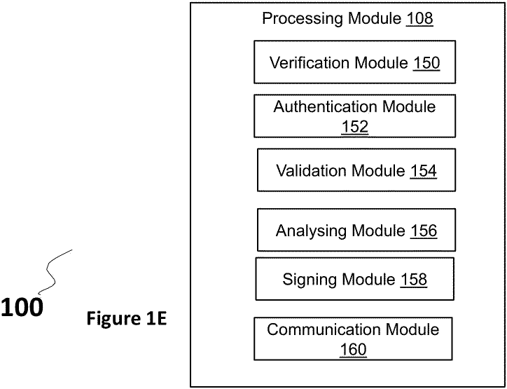

FIG. 1A illustrates a block diagram of a system 100 for storing a plurality of encryption keys. The system 100 comprises at least one user device 102 having a memory 120, a cloud server 104, a block 106 representing a blockchain (herein after referred to as ‘blockchain 106’), a processing module 108, and a backup storage device 110, according to embodiments of the present invention. Further, the at least one user device 102, the cloud server 104, the blockchain 106, the processing module 108 and the backup storage device 110 may be connected through a communication network 112, according to embodiments of the present invention.

The system 100 facilitates in storing a plurality of encryption keys which may be used for processing a secured transaction on a blockchain 106. The at least one user device may be configured to authorize at least one user for performing the secured transaction. The at least one user may be authorized based on verification of at least one identity information. A smart contract on the blockchain may be deployed for the at least one user. The smart contract may be associated with the plurality of encryption keys and may be created in response to a request to perform at least one transaction of the secured transaction. The plurality of encryption keys may include a set of public keys and a set of private keys. A first private key that is generated on the at least one user device may be stored in the memory 120 of the at least one user device 102. Further, a second private key may be stored in the cloud server 104, the first private key and the second private key belong to the set of private keys. A request may be initiated for the at least one transaction by using the second private key by the cloud server 104. Thereafter, a notification from the cloud server 104 may be received on the at least one user device 102 for signing the at least one transaction. Once the notification is received, the at least one user device 102 signs the at least one transaction. The signing of the at least one transaction is performed by using the first private key that is stored in the memory 120 of the at least one user device 102. The signed at least one transaction is thereafter sent on the blockchain to process the at least one transaction across the communication network 112.

The communication network 112 may include a data network such as, but not limited to, the Internet, a Local Area Network (LAN), a Wide Area Network (WAN), a Metropolitan Area Network (MAN), and so forth. In some embodiments of the present invention, the communication network 112 may include a wireless network, such as, but not limited to, a cellular network and may employ various technologies including an Enhanced Data Rates for Global Evolution (EDGE), a General Packet Radio Service (GPRS), and so forth. In some embodiments of the present invention, the communication network 112 may include or otherwise cover networks or sub-networks, each of which may include, for example, a wired or a wireless data pathway.

According to an embodiment of the present invention, the at least one user device 102, the cloud server 104, the blockchain 106, the processing module 108 and the backup storage device 110 may be configured to communicate with each other by one or more communication mediums connected to the communication network 112. The communication mediums include, but are not limited to, a coaxial cable, a copper wire, a fiber optic, a wire that comprise a system bus coupled to a processor of a computing device, and so forth. Embodiments of the present invention are intended to include or otherwise cover any type of the communication mediums, including known, related art, and/or later developed technologies.

The at least one user device 102 may be configured to authorize at least one user for performing the secured transaction. Further, the at least one user device 102 may be associated with the at least one user and the at least one user may be authorized based on verification of at least one identity information. The verification of at least one identity information of the at least one user is based on at least one of: a biometric verification, a passcode verification, a location-based verification, an audio recognition-based verification, digital certificates-based verification, emails, and text message-based verification. Embodiments of the present invention are intended to include or otherwise cover any type of the verification including known, related art, and/or later developed technologies. The location-based technique comprises a GPS, WIFI real time location unit (RTLS), and/or any combination thereof.

The at least one user device 102 as illustrated in FIG. 1D may comprise a user interface 114, biometric authentication means 116, a web-based platform 118, a memory 120, a controller 122, and so forth. According to an embodiment of the present invention, each user device 102 may be configured to enable a user to receive data and transmit data within the system 100. According to embodiments of the present invention, the at least one user device 102 may be, but not limited to, a mobile device, a smart phone, a tablet computer, a portable computer, a laptop computer, a desktop computer, a smart device, a smart watch, a smart glass, and so forth. Embodiments are intended to include or otherwise cover any type of the at least one user device 102, including known, related art, and/or later developed technologies.

The user interface 114 may be configured to enable the at least one user to input data and receive data while performing the secured transaction within the system 100. The user interface 114 may be configured to display output data associated with the system 100. The user interface 114 may be, but not limited to, a touch screen display, a graphical user interface, a digital display, and so forth. Embodiments of the present invention are intended to include or otherwise cover any type of the user interface 114 including known, related art, and/or later developed technologies.

The biometric authentication means 116 may be configured to authorize the at least one user based on biometric verification of at least one identity information. Further, the biometric authentication means 116 may be a part of the at least one user device 102. In another embodiment of the present invention, the biometric authentication means 116 may be associated with the at least one user device 102. According to embodiments of the present invention, the biometric authentication means 116 may comprise a camera, a fingerprint scanner, a palm reader, an iris scanner, a facial recognition reader, a gene detection unit, and so forth. Embodiments of the present invention are intended to include or otherwise cover any type of the biometric authentication means 116 including known, related art, and/or later developed technologies.

The web-based platform 118 may be downloaded on the at least one user device 102 associated with respect to the at least one user. Also, the web-based platform 118 may be opened in a browser of the at least one user device 102. The at least one user device 102 may be configured to allow the at least one user for user registration. Further, the at least one user device 102 may be communicably coupled with a communication network 112 for creating a user account using the web-based platform 118 installed on the user device 102. The web-based platform 118 may be configured to receive at least one identity information associated with the user when the registration is completed. The at least one identity information comprises a first name, a last name, a street address, a contact number, an email, user identity documents, and so forth. The web-based platform 118 installed on the at least one user device 102 may be configured to provide an interface to the user for uploading the user identity documents for verification. In an embodiment of the present invention, the user identity documents may be verified using an optical character recognition technique. The user identity documents may comprise, a passport, a driver’s license, a social security number, a utility bill, a biometric identification data, a user location data set, an AML (anti-money laundering) data, a KYC (know your customer) documents, a KYB (know your business) documents, any government issued document, and so forth. Embodiments of the present invention are intended to include or otherwise cover any type of the user identity documents including known, related art, and/or later developed technologies. In one embodiment a predetermined score may be incremented when the verification of the user is successful.

Further, the at least one user device 102 comprises the memory 120 that may be configured to store a portable identification (PID) 146 of the authorized at least one user. The portable identification (PID) 146 may be generated during the verification of at least one identity information. In one embodiment of the present invention, the portable identification (PID) stored in the memory 120 may be substituted by a one-time ID or identity number that may be salted by the at least one private key stored on the memory 120 of the at least one user device 102. The one-time ID comprises an ID from at least one identity documents that may be salted by the at least one private key stored on the memory 120. The memory 120 may be configured for storage and retrieval of the at least one identity information. According to embodiments of the present invention, the memory 120 may be, but is not limited to, an eSIM, an SD card, a Static Random-Access Memory (SRAM), a Dynamic Random-Access Memory (DRAM), Programmable Read-Only Memory (PROM), an Erasable Programmable Read-Only memory (EPROM), an Electrically Erasable Programmable Read-Only memory (EEPROM), a flash memory, an internal storage, an external storage, and so forth. Embodiments of the present invention are intended to include or otherwise cover any type of the memory 120 including known, related art, and/or later developed technologies.

Furthermore, the at least one user device 102 may comprise a RF transceiver 148 for controlling any device that may receive an IR signal. In an embodiment of the present invention, the secured transaction may include one or more transactions pertaining to cryptocurrencies, banking transactions, sensitive data transactions, identity information validation transactions. According to an embodiment of the present invention, each user device 102 may further include the controller 122 that may be configured to receive, transmit and process data associated with the system 100 using the communication network 112 to the cloud server 104 communicably connected with the at least one user device 102.

The cloud server 104 may be configured to accumulate data associated with the system 100. The cloud server 104 may be further configured to deploy a smart contract 142 on the blockchain 106 for the at least one user. Further, the smart contract 142 associated with the plurality of encryption keys may be created in response to a request to perform at least one transaction of the secured transaction. Moreover, the plurality of encryption keys may include the set of public keys and the set of private keys 144. In preferred embodiments of the present invention, the at least one transaction may comprise transferring of tokens, calling a cryptocurrency function of a smart contract by the second private key in the cloud server 104.

The at least one transaction may be a subset of the secured transaction, according to an embodiment of the present invention. The at least one user device 102 and the cloud server 104 may be separate devices that may store the first private key and the second private key respectively thereby allowing the first private key and the second private key to be independent of each other. The first private key is generated on the at least one user device. In one example, the blockchain 106 may be such as but not limited to, a public blockchain, a private blockchain, a hybrid blockchain, a consortium blockchain, and so forth.

Further, the cloud server 104 may comprise a server application 124, a processor 126, and so forth. In one embodiment of the present invention, the server application 124 may be installed on the cloud server 104 that may be configured to execute the generated one or more transactions. The server application 124 may be configured to read from one of the other pluralities of private keys stored on the cloud server 104 and send the generated transactions request to the blockchain 104 by processing the one or more transactions for execution using the processor 126 associated with the cloud server 104. The cloud server 106 may be communicably associated with the processing module 108 over the communication network 110.

The processing module 108 in communication with the at least one user device 102 and the cloud server 104 may be configured to store the first private key in the memory 120 of the at least one user device 102. The first private key may belong to the set of private keys 144. Further, the first private key and the second private key may correspond to the at least one transaction being processed on the blockchain 106.

The processing module 108 may further be configured to store the second private key in the cloud server 104, the second private key belonging to the set of private keys 144, initiate a request for the at least one transaction by using the second private key by the cloud server 104. The processing module 108 may be configured to send a notification, via the cloud server 104, to the at least one user device 102 for signing the at least one transaction. The processing module 108 may be configured to use the first private key, via the at least one user device, to generate a first signature in response to the at least one transaction for signing the at least one transaction. The processing module 108 may be further configured to send the signed at least one transaction on the blockchain 106 to process the at least one transaction.

Further, the system 100 may comprise a backup storage device 110 to store a third private key belonging to the set of private keys. The third private key may be used as a backup to perform the first transaction when the first private key and the second private key are compromised due to any unexpected event. Each private key from the set of private keys are stored in separate secured locations such that any private key stored at any location does not recognize any other key stored at any other location. In other words, each private key is independent of any other private key. Therefore, if a user has to sign any transaction, it can be signed by using the private key that is stored in respective user device only and not at by any other key that is stored at any other location. This ensures security and authentication of any transaction in process.

FIG. 1B illustrates a schematic representation of the process for storing the plurality of encryption keys in the at least one user device 102, according to embodiments of the present invention. At least one user may be associated with at least one user device 102 for storing the encryption keys. As seen particularly at 128, the at least one user may download the web-based platform 118 on the at least one user device 102. In another embodiment of the present invention, the at least one user may open the web-based platform 118 on the at least one user device’s browser.

As seen at 130, the at least one user device 102 may be configured for user registration by creating a user account using the web-based platform installed on the at least one user device 102. Each user may be required to verify the identity by verifying the at least one user identity information.

As seen particularly at 132, a smart contract 142 with a set of private keys 144 may be generated for each user. In preferred embodiments of the present invention, the smart contract 142 may comprise a multi-signature wallet that may be deployed on the blockchain 106 that may be further associated with the set of private keys, as depicted in FIG. 1C. In an exemplary embodiment of the present invention, the multi-signature wallet may be deployed on the blockchain 106 with for example, three public keys correlating with the three private keys. The smart contract 142 may comprise, daily limits, portable identification (PID) of the authorized at least one user based on the at least one identity information. Further, the first private key may be stored on a secure element present on the at least one user device 102 and the second private key stored on a hot storage that may be the cloud server 104. The third private key may be stored on a cold storage that may be the backup storage device110.

As seen at 134, a set of first transaction request may be generated to perform the secured transaction by initiating a set of first transaction by signing using the first private key stored in the secure element of the at least one user device. In an example, the first transaction request may comprise, transferring of tokens, calling a cryptocurrency function, creating sensitive data, storing sensitive data, dissemination of sensitive data, medical records, voting records, credit scores and/or a combination foregoing. Further, a notification may be received on the hot storage for signing the set of first transaction using the second private key stored on the hot storage. The server application 124 installed on the hot storage may be configured to read the second private key stored on the hot storage. The complete signed set of first transaction may be sent on the blockchain 106 to process and complete the secured transaction. According to embodiments of the present invention, the set of first transaction may comprise, an entire first transaction, a subset of the first transaction, and/or any combination foregoing.

In an embodiment of the present invention, the secured transaction may be completed by signing the set of first transaction using the second private key stored in the hot storage and the third private key stored in the cold storage, when the first private key stored in the secure element present in the at least one user device 102 is compromised due to any unexpected event. and send the generated first transaction request to blockchain for execution.

At 136, the secure element may receive notification from the hot storage over the blockchain 106. In preferred embodiments of the present invention, the secure element may be an eSIM that may be configured to receive eSIM prompts for authorization of the set of first transaction request for transferring tokens/call a function of the smart contract 142.

At 138, the user authorizes the set of first transaction for transferring tokens/call a function using the biometric authentication technique/ passcode, allowing the first private key stored on the eSIM to approve the set of first transaction by signing performing hashing for executing the smart contract 142. Further, signed set of first transaction that may be an entire first transaction/a subset of the first transaction, and hashed set of first transaction may be sent over the blockchain for the complete secure transaction.

Referring to particularly FIG. 1A described in conjunction to FIGS. 1B, 1C and 1D. The system 100 may be configured to store one or more encryption keys generated for at least one cryptocurrency wallet in a non-removable tamper-proof secure element, present in at least one user device 102 for enhancing multi-factor authentication. In an exemplary embodiment of the present invention, a user device 102 may receive the at least one identity information when registration of a user is completed. Further, FIG. 1E illustrates a block diagram of components of a processing module 108 of the system 100, according to embodiments of the present invention. The processing module 108 may comprise a verification module 150, an authentication module 152, a validation module 154, an analyzing module 156, a signing module 158, a communication module 160, and so forth.

The verification module 150 may be configured to receive the identity information of one or more users from the cloud server 104 over the communication network 112. The identity of the user may be verified using a verification module 150 by implementing an optical character recognition technique on the received identity information. Further, a predetermined score may be incremented when the verification is successful. Once the user is verified, the user’s identity may be authenticated using the authentication module 152.

The user may be authenticated using a plurality of authentication techniques associated with the authentication module 152. The authentication module 152 may increment the predetermined score when authentication is successful. The authentication techniques may comprise, a texture analysis technique, a location-based authentication technique, an audio recognition technique, a biometric authentication technique, a pattern tracing technique, a social marker, a near field communication (NFC) technique, a Bluetooth short range peer-to-peer authentication technique, non-text passwords, where symbols or images might be chosen from a randomly-generated field, digital certificates using public key infrastructure, a One-time password (OTP) authentication technique, an email authentication technique, SMS messages and the authentication techniques comprise a hybrid authentication technique that involves a government and non-government authentication.

The pattern tracing technique may comprise, a mobile-device use, web searches, a location tracing, SMS messages to certain numbers, and so forth.

The social marker comprises a disclosure of unique media posts such as but not limited to, pictures, video, audio, association with others, and so forth.

The biometric authentication technique may comprise, a fingerprint recognition technique, a facial recognition technique, a genetic identification technique, a partial genetic strand authentication technique, a retina or iris scan technique, a voice recognition technique, a complete genetic strand authentication technique, and so forth.

The user validation module 154 may be configured to receive a real-time image or a video of the user captured through the camera of the user device 102 for matching with the authenticated identity information. The predetermined score may be incremented when the match is found. The validation module 154 may transmit the predetermined score to the analyzing module 156 for comparing the obtained predetermined score with a threshold value. When the obtained predetermined score is above the threshold value, the user is a validated user and when the obtained predetermined score is below the threshold value, a notification is sent to an operator for proceeding with manual review of the identity information. The threshold value may be any user input value.

Further, the analyzing module 156 may be configured to check the user being in records of global watchlists. The global watchlists may comprise, Government Sanctions Lists, Politically Exposed Persons (PEP) Lists, Adverse Media including Terrorism, Money Laundering, Regulatory Action, Most Wanted lists, and so forth.

Furthermore, when the validated user with no records found in global watchlists is obtained, the smart contract 142 may be deployed on the blockchain 106 having parameters comprising, a public address of the blockchain, a set of public keys, a set of private keys, daily limits, a portable identification (PID), and so forth. Moreover, the portable identification (PID) 146 may be continuously verified by scanning databases, verifying government issued user identity documents, monitoring transactions, and so forth.

The one or more transaction may be securely executed using the set of private keys stored on the user device 102. The signing module 158 may be configured to receive the set of transaction request and signing the received set of transaction by the at least one private key stored on the non-removable tamper-proof secure element. The communication module 160 may be configured to send the signed set of transaction to the smart contract associated with the blockchain.

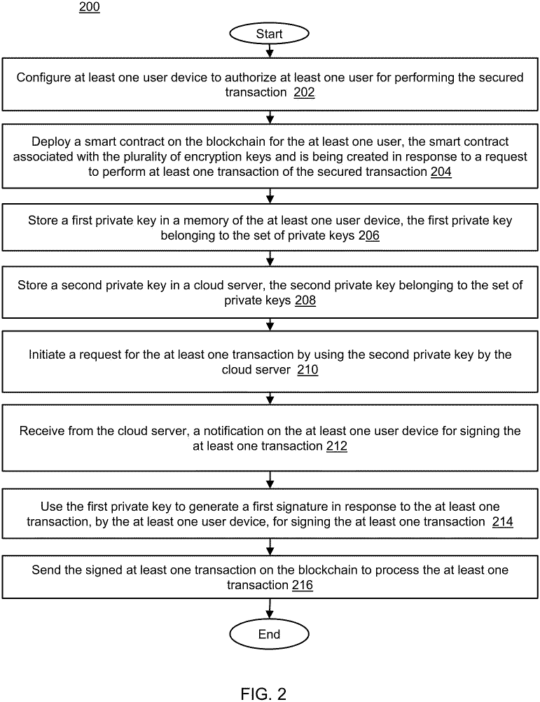

FIG. 2 is an illustration of step and method 200 for storing a plurality of encryption keys for processing a secured transaction on the blockchain 106, according to an embodiment of the present invention.

At 202, at least one user device 102 may be configured to authorize at least one user for performing the secured transaction. The at least one user device 102 may be associated with the at least one user. Further, the at least one user being authorized based on verification of at least one identity information. According to embodiments of the present invention, the secured transaction includes one or more transactions pertaining to cryptocurrencies, banking transactions, sensitive data transactions, identity information validation transactions.

At 204, the smart contract 142 may be deployed on the blockchain 106 for the at least one user. The smart contract 142 may be associated with the plurality of encryption keys and is being created in response to a request to perform at least one transaction of the secured transaction. The plurality of encryption keys including a set of public keys and a set of private keys 144. Further, the at least one transaction may include transferring of tokens, calling a cryptocurrency function of a smart contract by the second private key in the cloud server.

At 206, the first private key may be stored in the memory 120 of the at least one user device 102. The first private key may belong to the set of private keys 144. The first private key may correspond to the at least one transaction being processed on the blockchain 106.

At 208, the second private key may be stored in the cloud server 104. The second private key may belong to the set of private keys 144. The second private key may correspond to the at least one transaction being processed on the blockchain 106.

At 210, the second private key stored on the cloud server 104 may initiate a request for the at least one transaction. The at least one transaction may a subset of the secured transaction.

At 212, the cloud server 104 may receive a notification on the at least one user device 102 for signing the at least one transaction.

At 214, the first private key may be utilized to generate a first signature in response to the at least one transaction, by the at least one user device 102, for signing the at least one transaction.

At 216, the signed at least one transaction may be sent on the blockchain 106 to process the at least one transaction.

Embodiments of the invention are described above with reference to block diagrams and schematic illustration of methods and systems, according to embodiments of the present invention. It will be understood that each block of the diagrams and combination of blocks in the diagrams can be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

What is claimed is:

1. A method for storing a plurality of encryption keys, the plurality of encryption keys being used for processing a secured transaction on a blockchain, the method comprising:
configuring at least one user device to authorize at least one user for performing the secured transaction, the at least one user device associated with the at least one user, the at least one user being authorized based on verification of at least one identity information;
deploying a smart contract on the blockchain for the at least one user, the smart contract associated with the plurality of encryption keys and is being created in response to a request to perform at least one transaction of the secured transaction, the plurality of encryption keys including a set of public keys and a set of private keys;
storing a first private key in a memory of the at least one user device, the first private key generated on the at least one user device and belonging to the set of private keys;
storing a second private key in a cloud server, the second private key belonging to the set of private keys;
initiating a request for the at least one transaction by using the second private key by the cloud server;
receiving from the cloud server, a notification on the at least one user device for signing the at least one transaction;
using the first private key to generate a first signature in response to the at least one transaction, by the at least one user device, for signing the at least one transaction; and
sending the signed at least one transaction on the blockchain to process the at least one transaction.

2. The method of claim 1, wherein the secured transaction includes one or more transactions pertaining to cryptocurrencies, banking transactions, sensitive data transactions, identity information validation transactions.

3. The method of claim 1, wherein the at least one transaction includes transferring of tokens, calling a cryptocurrency function of a smart contract by the second private key in the cloud server.

4. The method of claim 1, wherein the at least one transaction is a subset of the secured transaction.

5. The method of claim 1, wherein the first private key and the second private key corresponds to the at least one transaction being processed on the blockchain.

6. The method of claim 1, wherein the at least one user device and the cloud server are separate devices that store the first private key and the second private key respectively thereby allowing the first private key and the second private key to be independent of each other.

7. The method of claim 1, further comprising storing a third private key in a backup storage device, the third private key belonging to the set of private keys.

8. The method of claim 7, wherein the third private key is used as a backup to perform the first transaction when the first private key and the second private key are compromised due to any unexpected event.

9. The method of claim 1, wherein the verification of at least one identity information of the at least one user is based on at least one of: a biometric verification, a passcode verification, a location-based verification, an audio recognition-based verification, digital certificates-based verification, emails, and text message-based verification.

10. The method of claim 1, wherein a portable identification (PID) of the authorized at least one user is stored in the memory of the at least one user device, the portable identification (PID) being generated during the verification of at least one identity information.

11. A system for storing a plurality of encryption keys, the plurality of encryption keys being used for processing a secured transaction on a blockchain, the system comprising:
at least one user device configured to authorize at least one user for performing the secured transaction, the at least one user device associated with the at least one user, the at least one user being authorized based on verification of at least one identity information;
a cloud server configured to deploy a smart contract on the blockchain for the at least one user, the smart contract associated with the plurality of encryption keys and is being created in response to a request to perform at least one transaction of the secured transaction, the plurality of encryption keys including a set of public keys and a set of private keys;
a processing module in communication with the at least one user device and the cloud server, the processing module configured to:
store a first private key in a memory of the at least one user device, the first private key generated on the at least one user device and belonging to the set of private keys;
store a second private key in the cloud server, the second private key belonging to the set of private keys,
initiate a request for the at least one transaction by using the second private key by the cloud server;
send a notification, via the cloud server, to the at least one user device for signing the at least one transaction;
use the first private key, via the at least one user device, to generate a first signature in response to the at least one transaction for signing the at least one transaction; and
send the signed at least one transaction on the blockchain to process the at least one transaction.

12. The system of claim 11, wherein the secured transaction includes one or more transactions pertaining to cryptocurrencies, banking transactions, sensitive data transactions, identity information validation transactions.

13. The system of claim 11, wherein the at least one transaction includes transferring of tokens, calling a cryptocurrency function of a smart contract by the second private key in the cloud server.

14. The system of claim 11, wherein the at least one transaction is a subset of the secured transaction.

15. The system of claim 11, wherein the first private key and the second private key corresponds to the at least one transaction being processed on the blockchain.

16. The system of claim 11, wherein the at least one user device and the cloud server are separate devices that store the first private key and the second private key respectively thereby allowing the first private key and the second private key to be independent of each other.

17. The system of claim 11, further comprising a backup storage device to store a third private key belonging to the set of private keys.

18. The system of claim 17, wherein the third private key is used as a backup to perform the first transaction when the first private key and the second private key are compromised due to any unexpected event.

19. The system of claim 11, wherein the verification of at least one identity information of the at least one user is based on at least one of: a biometric verification, a passcode verification, a location-based verification, an audio recognition-based verification, digital certificates-based verification, emails, and text message-based verification.

20. The system of claim 1, wherein a portable identification (PID) of the authorized at least one user is stored in the memory of the at least one user device, the portable identification (PID) being generated during the verification of at least one identity information.
